(19) United States
(12) Patent Application Publication
(10) Pub. No.: US 2015/0262229 A1
(43) Pub. Date: Sep. 17, 2015

(54) TARGETED AD REDISTRIBUTION

(71) Applicant: Gracenote, Inc., Emeryville, CA (US)

(72) Inventors: Vadim Brenner, San Francisco, CA (US); Markus K. Cremer, Orinda, CA (US)

(73) Assignee: Gracenote, Inc., Emeryville, CA (US)

(21) Appl. No.: 14/206,497

(22) Filed: Mar. 12, 2014

(51) Int. Cl. G06Q 30/02; G06Q 50/00

(52) U.S. Cl. CPC G06Q 30/0251; G06Q 50/01

(57) ABSTRACT

A user may view a video. The user may share a portion or the entirety of the video. The user may provide tags or comments with the shared video. The tags or comments may indicate a mood associated with the shared video. The server receiving the request to share the video may have metadata associated with the video. Additional metadata may be stored associated with smaller portions of the video. As an example, metadata may indicate the mood of a scene. The server may embed one or more advertisements into the shared video. The one or more advertisements may be targeted. Selection of advertisements may be based on a match between advertisement metadata and a user profile of the sharing user, a user profile of the receiving user, tags or comments provided by the sharing user, and metadata for the video or the clip.

### TECHNICAL FIELD

The subject matter disclosed herein generally relates to the processing of data. Specifically, the present disclosure addresses systems and methods to target advertisement (ad) redistribution.

### BACKGROUND

A user may watch a movie or other video content on a video playback device such as a television or personal computer. The user may share the video content with a friend, for example by sending a uniform resource locator (“URL”) for the video content by instant messaging, email, or a social network. The user receiving the video content may view the video content. The video content may include advertisements.

A user may listen to a podcast or other audio content on an audio playback device such as a radio or personal computer. The user may share the audio content with another user, for example by sending a URL for the audio content by instant messaging, email, or a social network. The user receiving the audio content may listen to the audio content. The audio content may include advertisements.

Advertising may be targeted based on demographic data. For example, a television or radio network broadcast may include advertising slots to be filled with different local advertising by different local television or radio stations. As another example, a user who has shown interest in a certain product may be shown advertisements for that product or related products.

### BRIEF DESCRIPTION OF THE DRAWINGS

Some embodiments are illustrated by way of example and not limitation in the figures of the accompanying drawings.

FIG. 1 is a block diagram depicting a system, in an example embodiment, for targeted ad redistribution.

FIG. 2 is a block diagram illustrating a user computing device, in an example embodiment, for targeted ad redistribution.

FIG. 3 is a block diagram illustrating a server machine, in an example embodiment, for targeted ad redistribution, according to an example embodiment.

FIGS. 4-5 are block diagrams illustrating user interfaces, in example embodiments, suitable for targeted ad redistribution.

FIGS. 6-8 are flowcharts illustrating methods, in example embodiments, for targeted ad redistribution.

FIG. 9 is a diagrammatic representation of a machine in the example form of a computer system within which a set of instructions may be executed for causing the machine to perform any one or more of the methodologies discussed herein.

### DETAILED DESCRIPTION

Example methods and systems are directed to targeted ad redistribution. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A user may consume media. For example, a user may view a video by watching a program on broadcast TV, on cable TV, or over the Internet. Playback of the program may, or may not, be under the user's control. For example, the user may be able to pause, rewind, fast-forward, or skip segments of the program. Alternatively, playback of the program may be under the presenter's control, with the user prevented from performing some or all playback operations. The program may be of varying lengths, from a short clip only a few seconds long, to a feature film over two hours in length, to a continuous stream of indefinite length.

As another example, a user may listen to audio media by listening to a program, song, or audio book on broadcast radio, satellite radio, or over the Internet. As described above with respect to video media, playback of the audio program may be under the listener's control, under the presenter's control, or both.

The user may share a portion or the entirety of the media. In some example embodiments, the user accesses a video to be shared using a web browser or television. In this example, the user may use a computer to indicate the television channel being watched, the start and end times of a selected clip, and a destination to a server in a share request. The server may have received multiple television programs and stored them in a database. Based on the clip information provided by the user, the server may identify the selected video and the selected portion of that video. Based on the destination, the server may send the selected portion of the video to a target user. For example, the destination may be an email address and the server may generate a video clip and send it as an attachment to the email address. As another example, the destination may be a phone number and the server may generate a video clip and send it using a multimedia messaging service (“MMS”).

In some example embodiments, the user accesses audio media to be shared using a web browser or radio. In this example, the user may use a computer to indicate the radio station being listened to, the start and end times of a selected clip, and a destination to a server in a share request. The server may have received multiple radio programs and stored them in a database. Based on the clip information provided by the user, the server may identify the selected audio and the selected portion of that audio. Based on the destination, the server may send the selected portion of the audio to a target user. For example, the destination may be an email address and the server may generate an audio clip and send it as an attachment to the email address. As another example, the destination may be a phone number and the server may generate an audio clip and send it using MMS.

In an example embodiment, the user may provide tags or comments with the shared media. The tags or comments may indicate a mood associated with the shared media. For example, if the sharing user thought the media was funny, the sharing user might tag the shared media with “#LOL.” Likewise, if the sharing user thought the media was cute, the sharing user might include a comment such as “awww.” It will be appreciated that any other tag, custom or otherwise, may be included by the sharing user.

The server receiving the request to share the media may have metadata regarding the media. For example, a movie may have metadata indicating the director, the cast, the genre (e.g., drama, comedy, action), and the mood (e.g., sad, silly, serious, funny). Additional metadata may be stored regarding smaller portions of the movie (e.g., a frame, a clip, a scene). For example, metadata may indicate items, characters, or actors shown on-screen. As another example, metadata may indicate the mood of a scene. To illustrate, a drama may have a serious tone overall, but contain several light-hearted scenes. Accordingly, the film overall may have a “serious” mood, but the scenes may have a “funny” mood. The scenes may be identified by number (e.g., a scene number on a digital versatile disc (“DVD”)) or by start and end times (e.g., a clip from 30:06 to 30:09 of the film).

As another example, an album may have metadata indicating the artist, the genre (e.g., rock, rap, country), and the mood (e.g., upbeat, somber, aggressive). Additional metadata may be stored regarding smaller portions of the album (e.g., a song, a track, a movement). For example, metadata may indicate tempo, lyrics, personalities or artists involved in all of or a portion of the audio. As another example, metadata may indicate the mood of a song. To illustrate, a heavy-metal album may have an aggressive tone overall, but contain a romantic rock ballad. Accordingly, the album overall may have an “aggressive” mood, but the ballad may have a “romantic” mood. The songs may be identified by number (e.g., a scene number on a compact disc (“CD”)) or by start and end times (e.g., a clip from 1:30 to 4:00 of the album).

The server may embed or associate one or more advertisements into the shared media. For example, an advertisement may be placed at the beginning of the media, such that the receiving user must allow the advertisement to play before the shared media will begin. Alternatively, the advertisement may be placed in the media, such that a portion of the media will play before or after the advertisement. As another example, the advertisement may be a display advertisement (e.g., an image or text advertisement) displayed near to or overlaid on top of the video, or presented simultaneously with the playback of the audio.

The one or more advertisements may be targeted advertisement. For example, the advertisements may have metadata indicating actors, items, or mood. Selection of advertisements may be based on a match between advertisement metadata and a user profile of the sharing user, a user profile of the receiving user, tags or comments provided by the sharing user, and/or metadata for the media or the clip. For example, an advertiser may provide two ads, one of which extols the scientific benefits of a product and the other of which shows how much fun the product is to use. The ad discussing scientific benefits may have a “serious” mood, while the other ad may have a “fun” mood. Based on the tags, comments, and/or metadata indicating a serious mood for the shared media, the ad showing the benefits of the product may be chosen. Alternatively, based on the tags, comments, or metadata indicating a fun mood for the shared media, the ad showing how fun the product is may be chosen.

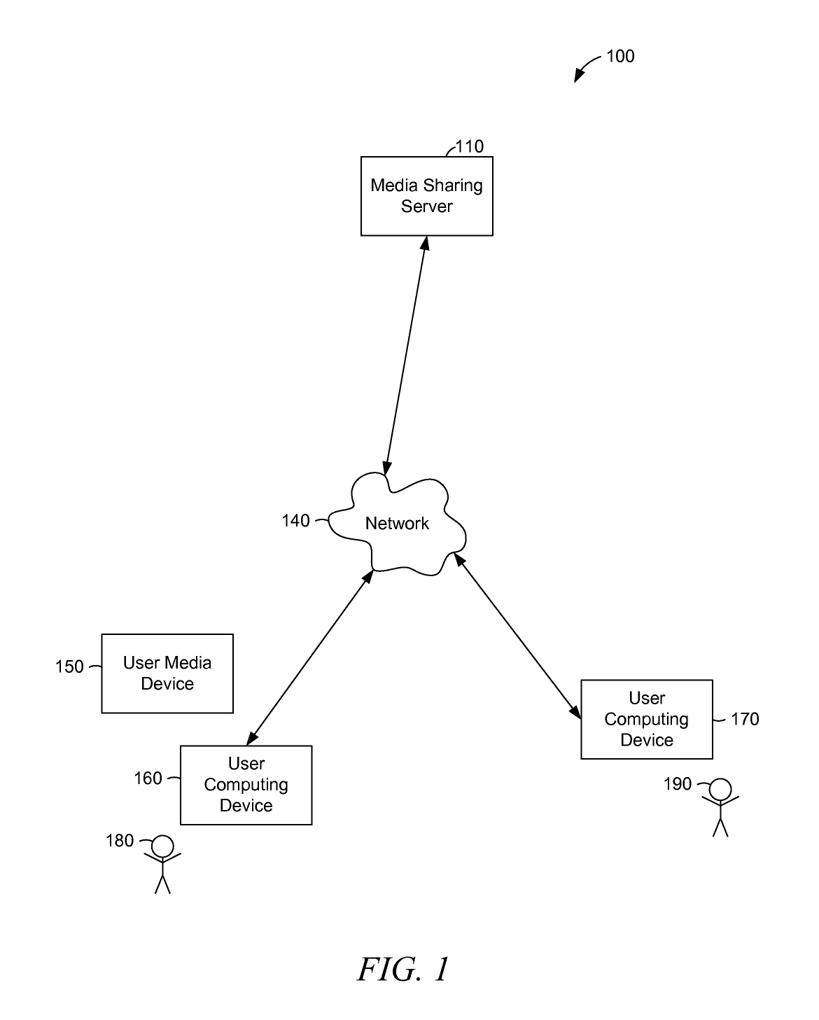

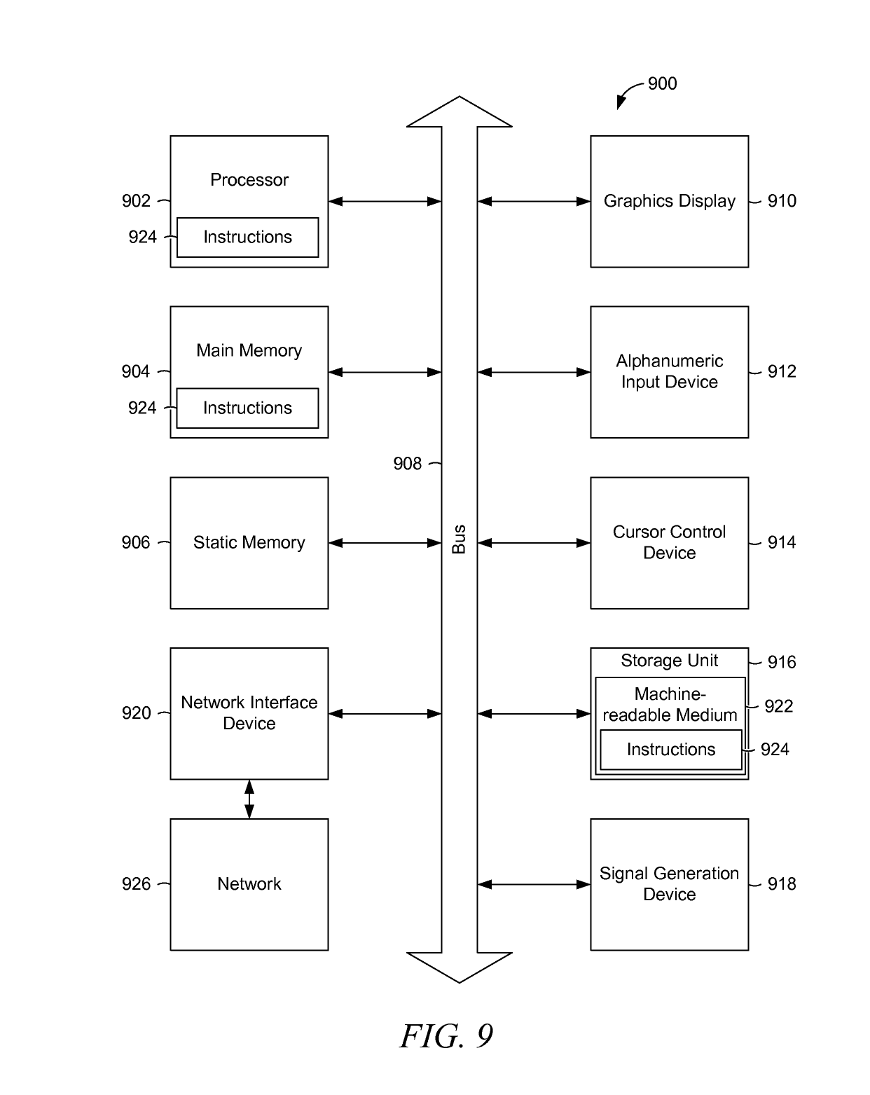

FIG. 1 is a network diagram illustrating a network environment 100 suitable for targeted ad redistribution, according to some example embodiments. The network environment 100 is shown to include one or more media sharing servers (or machines) 110 and user computing devices 160 and 170, all communicatively coupled to each other via a network 140 (or a series of networks). In some example embodiments, the media sharing server 110 is connected by the network 140 or one or more other networks to other servers hosting advertisements, media, and user metadata. The machines and devices 110, 150, 160, and 170 may each be implemented in a computer system, in whole or in part, as described below with respect to FIG. 9. The user media device 150 may be any device capable of media playback. For example, the user media device 150 may be a TV receiver or a radio. The user media device 150 may also be a computing device, such as a smartphone, tablet, desktop computer, or any other electronic device capable of presenting or displaying media to a user.

Also shown in FIG. 1 are users 180 and 190. One or both of the users 180 and 190 may be a human user, a machine user (e.g., a computer configured by a software program to interact with the user computing device 160 or 170), or any suitable combination thereof (e.g., a human assisted by a machine or a machine supervised by a human). The user 180 is shown by way of example not to be part of the network environment 100, but is associated with the device 160 and may be a user of the device 160. For example, the device 160 may be a desktop computer, a vehicle computer, a tablet computer, a navigational device, a portable media device, a smartphone, or the like. Likewise, the user 190 is shown not to be part of the network environment 100, but is associated with the device 170. As an example, the device 170 may be a desktop computer, a vehicle computer, a tablet computer, a navigational device, a portable media device, or a smartphone.

The user 180 may view media presented by the user media device 150. For example, the user media device 150 may be a television or radio presenting video or audio media. The media may originate from a broadcast, cable, or satellite TV or radio station. In addition or instead, the media may be received over a computer network such as the Internet.

The user 180 may indicate a portion of the media received by the user media device 150. For example, the user 180 may interact with a graphical user interface presented by the user computing device 160 to select a channel or station for the media along with a start and end time for the selected portion. The user media device 150 may be part of the user computing device 160. The indicated portion of the media, or an indication of the portion of the media, may be sent to the media sharing server 110 via the network 140. Additionally, the user 180 may provide tags or comments regarding the selected portion of the media. The tags or comments may also be sent from the user computing device 160 to the media sharing server 110 via the network 140. The user 180 may also provide one or more user identifiers or destination addresses to which the indicated portion of the video should be sent. For example, a user may be identified by name, email address, phone number, or relationship with the sending user.

The media sharing server 110 may receive the share request from the user computing device 160. Based on information in the share request, the media sharing server 110 may identify the selected portion of media in a database and access metadata associated with the selected media. For example, metadata indicating a mood, actors shown, items shown, and items discussed may be accessed. Additional metadata for the share request may be obtained from the tags or comments provided by the sharing user, and by gathering metadata for the sharing user and the destination user from a user metadata server. Based on the metadata for the share request, one or more advertisements may be retrieved from an advertisement server. The user 190 may be a destination user, to whom the retrieved advertisements and the shared media may be presented by the user computing device 170.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 9. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 140 may be any network that enables communication between or among machines, databases, and devices (e.g., the media sharing server 110 and the user computing device 160). Accordingly, the network 140 may be a wired network, a wireless network (e.g., a mobile or cellular network), or any suitable combination thereof. The network 140 may include one or more portions that constitute a private network, a public network (e.g., the Internet), or any suitable combination thereof.

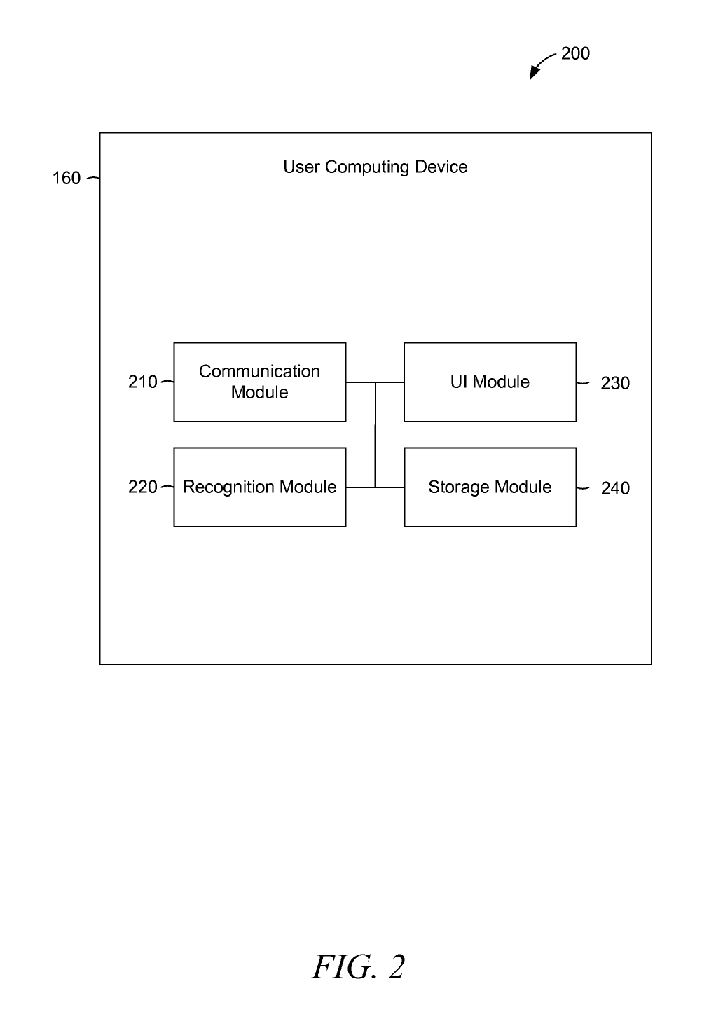

FIG. 2 is a block diagram 200 illustrating modules of the user computing device 160, according to an example embodiment. The user computing device 160 is shown as including a communication module 210, a recognition module 220, a user interface (“UI”) module 230, and a storage module 240, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The recognition module 220 may recognize the media being consumed by a user (e.g., user 180) of the user computing device 160. For example, if the user is streaming media from a web site using a web browser running on the user computing device 160, the recognition module 220 may detect the URL of the web site, read cookies sent by the web site, or otherwise identify the media being played by the web site. As another example, if the user is watching a television broadcast on the user media device 150, the recognition module 220 may detect the audio track of the media using a microphone and compare the audio with audio currently being broadcast by TV stations in the user's area. To illustrate, the audio may be captured and compressed by the recognition module 220, then sent to the media sharing server 110 by the communication module 210 over the network 140. The media sharing server 110 may access a media database and compare the received audio with stored audio for one or more programs. Based on detecting a match between the received audio and the stored audio, a name or other identifier of a matching program may be sent by the media sharing server 110. This method can also be used to identify audio media such as a radio broadcast. Similar methods allow for identifying visual media by matching images captured with a camera of the user computing device 160 with an image or video database.

Alternatively, the recognition module 220 may work with the UI module 230 to present a user interface to the user 180. The presented UI may allow the user 180 to identify the media. For example, the user computing device 160 may include a global position satellite (“GPS”) receiver that identifies the position of the user computing device 160. Based on the position of the user computing device 160, a database can be accessed to determine the broadcast media that are currently available to the user 180. A drop-down list containing the names of the available broadcast media may be presented to the user 180. Based on a selection by the user 180, the recognition module 220 may identify the media.

The UI module 230 may present a user interface to the user 180. The user interface may allow the user 180 to select a portion of the identified media to share. For example, text fields may be presented. The user 180 may enter the start and stop times into the text fields, or a start time and a duration. As another example, a slider may be presented with two time indicators. The left edge of the slider may represent the beginning of the media and the right edge of the slider may represent the end of the media. The UI may allow the user 180 to position start and end markers on the media, indicating the start and end times of the selected portion, respectively.

The UI presented by the UI module 230 may allow the user 180 to indicate one or more destinations for the shared media. For example, the user 180 may enter a user name, email address, phone number, or other identifier into a text field. As another example, a contact list from an email application or social network may be used to populate a drop-down list. As another example, icons representing other users may be presented on a touch screen, selectable by the user 180 touching each icon.

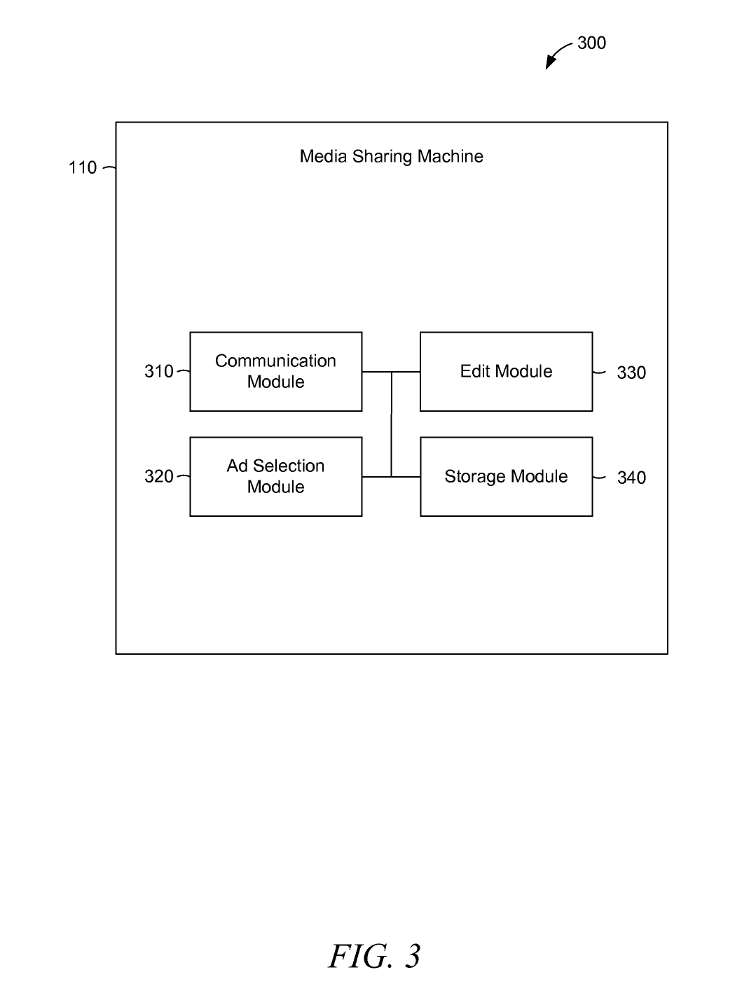

The selected destinations and information regarding the selected media clip may be sent via the communication module 210 to the media sharing server 110. For example, the information may be sent via hypertext transport protocol (“HTTP”) using transmission control protocol/Internet protocol (“TCP/IP”) packets. The information received by the media sharing server 110 may be processed by modules discussed in more detail with respect to FIG. 3 below.

FIG. 3 is a block diagram 300 illustrating modules of the media sharing server 110, according to an example embodiment. The media sharing server 110 is shown as including a communication module 310, an ad selection module 320, an edit module 330, and a storage module 340, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 310 may receive a share request from the user computing device 160. The share request may identify a media clip to be shared and a destination address to send the clip to or a target user to share the clip with.

The ad selection module 320 may access metadata regarding the clip, the sharing user, advertisements, and the destination address or target user. The ad selection module 320 may also access tags or comments regarding the clip submitted by the sharing user or other users. Based on the metadata, tags, and comments, matches may be generated between the clip, the sharing user, and the destination address or target user on the one hand and advertisements on the other. Based on the matches, an advertisement may be selected.

The matches may be applied in a weighted or hierarchical manner. For example, in a weighted application, a predetermined percentage weight may be applied to each category of match. To illustrate, matches between metadata regarding the sharing user and the advertisement may have a weight of 20%; matches between metadata regarding the target user and the advertisement may have a weight of 20%; matches between metadata regarding the shared clip and the advertisement may have a weight of 40%; and matches between the tags and comments and the advertisement may have a weight of 20%. As another example, in a weighted application, the percentage weight for each category may vary. For example, if advertisements that are strong matches for the receiving user have a higher conversion rate than advertisements that are strong matches for the shared clip, the weight given to matches between metadata for the shared clip and the advertisement may be reduced, and the weight given to matches between metadata for the target user and the advertisement may be increased.

As an example of a hierarchical application, each category of match may have a place in a priority list, such that the most-important category dominates and less-important categories are successively considered only when the match at the more-important level is substantially equal. To illustrate, the match between metadata regarding the target user and metadata for the advertisement may have the highest priority. Among advertisements that are tied in relevance for the target user, the match between the metadata regarding the clip and the advertisement may be considered the next-highest priority. Then, among advertisements that remain tied, the match between the tags and comments provided by the sharing user and the advertisement may be considered. This tie-breaking process may be continued to arbitrary depths, with ultimate ties determined randomly or in another manner.

The edit module 330 may retrieve the clip and the advertisement from the storage module 340 and edit the advertisement into the clip. For example, if the advertisement is a banner ad and the media clip is a video clip, the banner ad may be superimposed over the video clip by the edit module 330 to create a new video clip including the advertisement. As another example, if the advertisement is an audio ad and the clip is an audio clip, the audio ad may be prepended to the audio clip, inserted in the middle of the audio clip, or appended to the audio clip.

The communication module 310 may send the clip to the receiving user. For example, the clip may be sent as an attachment to an email. As another example, a pointer for the clip (e.g., a URL or other identifier) may be sent in the body of an email or as a private or public message on a social media site. In some example embodiments, the pointer for the clip identifies a larger piece of media that the clip is a part of, along with an offset from the beginning of the larger piece of media that indicates the starting point of the clip. For example, a media clip may be identified as being part of a particular movie, starting 37 minutes and 10 seconds from the beginning of the movie. The end of the clip may be indicated by an offset from the beginning of the movie, an offset from the beginning of the clip, or indicated in some other way. In some example embodiments, the end of the clip is automatically determined based on the media itself. For example, a scene change or song end may be detected and automatically used as the end of the media clip.

A record in a database may be created or updated by the storage module 340 to reflect the sending of the advertisement to the user, the presenting of the advertisement to the user, or both. For example, a table may contain records indicating, for each user, the number of times a particular advertisement was sent to each user, the number of times a particular advertisement was viewed by each user, the number of times ads for a particular product were sent to each user, the number of times ads for a particular product were viewed by each user, the number of times ads for a particular store or brand were sent to each user, and the number of times ads for a particular store or brand were viewed by each user. The number of times a particular ad, or other ads for a particular store, brand, or product have been sent to or viewed by a user may be referred to as a send count or view count of the ad, store, brand, or product. The ad selection module 320 may consider the send count or view count of an ad, a product advertised by the ad, a store associated with the ad, or a brand associated with the ad in determining whether to send the ad. For example, an advertising campaign may be more effective if the frequency of presentations of advertisements falls within a certain range (e.g., between 5 and 25 presentations per week). To cause the desired presentation frequency, the count of presentations of each ad in the period of interest may be considered, and an ad selected based on the count. To illustrate, three ads may be available for presentation. The first ad may have been presented to the target user 10 times in the past week, the second ad may never have been presented to the target user, and the third ad may have been presented 4 times in the past week. Based on these counts and a desired presentation rate of 5-25 presentations per week, the third ad may be selected to be presented, in order to increase its presentation count to 5, putting it into the desired presentation rate range.

Metadata regarding users (e.g., a sharing user and a receiving user) may indicate the interests, brand associations, media consumption history, sharing history, and friends of the users. For example, a user may be associated with a brand of phone because the user answered a survey and indicated that he or she owned a phone of that brand. As another example, the metadata may indicate that the user has an interest in a particular sport, a particular movie star, or a particular author. The media consumption history may be a viewing history, a listening history, or a web browsing history. For example, a user may have a digital video recorder (“DVR”) that tracks programs recorded for or viewed by a user. The DVR may communicate information regarding the viewed programs to the media sharing server 110. The media sharing server 110 may store the data regarding the viewed programs in a database. Based on the viewing history, other data regarding the user may be derived. For example, if the user has watched many movies with the same star, a determination that the user is a fan of the star may be made. Likewise, if the user has listened predominantly to music in a certain genre, an association between the user and the genre may be created. The sharing history may indicate media previously shared by the user. For example, metadata regarding a sharing user's sharing history may be a list of media clips shared by the sharing user, or data derived from the media clips shared, such as a count of the number of times clips with a particular actor, character, event, or mood have been shared.

As another example, metadata regarding the receiving or sharing user may include the location of the user and time of day, day of the week, or season of the year that the media was consumed or shared. For example, if the user is in a region that experiences snow and the season is winter, advertisements for winter clothing or snow tires may be generated. As another example, if the user is listening to the media in a car, advertisements for car accessories may be generated.

The media may be shared with a group of people. In this case, ads may be selected for presentation to the group or ads may be selected for presentation to each member of the group. For example, metadata regarding the members of the group may be aggregated to identify metadata for the group. As another example, metadata for the group may be stored independently of the metadata for the individual members. Additionally, a calculation may be performed to determine the distance of the interests of each member from the interests of the group. For example, an n-dimensional space of interests can be created. Each member of the group and the group itself can be assigned a vector of length n to locate the corresponding interests at a location in the n-dimensional space. A distance can be defined to determine users that have interests similar to those of the group. When a user's interests are within the predetermined distance of the interests of the group, advertisements generated for the group may be presented to the user. When the difference between the user's interests and the group interests exceed the predetermined distance, the user may receive advertisements based on the metadata for the user instead of the metadata for the group.

The selection of the advertisement by the ad selection module 320 may be based on the user metadata. For example, the viewing history of the sending or receiving user may include many movies including car chases, suggesting that a car ad be presented to the receiving user. The metadata of the sending user may be given additional weight based on an overlap with the metadata of the receiving user. For example, if both the sending user and the receiving user have an interest in cars, but only the sending user has an interest in flowers and only the receiving user has an interest in rock music, the probability of presenting an ad for a car or automobile product may be increased more than the probability of presenting an ad for flowers or rock music. As another example, the user metadata may be used to identify a user demographic, and the advertisements selected by the ad selection module 320 may be based on the user demographic. For example, based on the interest of the user in certain musical acts, actors, and the like, an age and gender of the user may be identified. Based on the identified age and gender, advertisements may be selected.

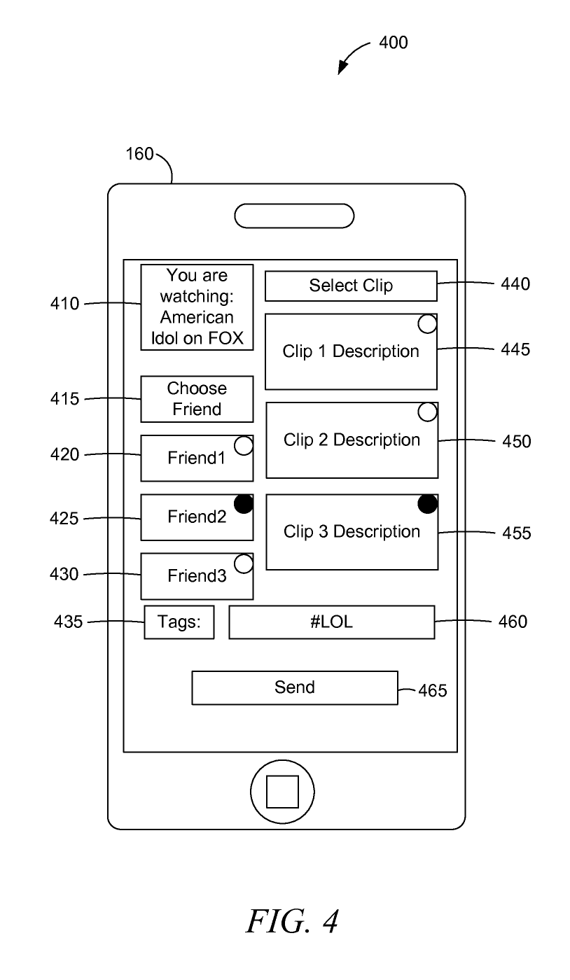

FIG. 4 is a block diagram illustrating a user interface 400 suitable for targeted ad redistribution, according to an example embodiment. The user interface may be displayed on the user computing device 160, for operation by a user sharing a media clip. The element 410 presents information regarding the media currently being consumed by the user. The element 415 prompts the sharing user to select one or more friends to share the media with. The elements 420, 425, and 430 are operable to select the friends to share with, as indicated by the radio button in each element. In this example, the radio button of element 425, corresponding to “Friend2,” has been filled, indicating that “Friend2” is a target user of the media clip.

The element 440 prompts the sharing user to select a clip of the media to share. The elements 445, 450, and 455 are operable to share the clip or clips to share, as indicated by the radio button in each element. The clip descriptions may be text, image, or video. In this example, the radio button of element 455, corresponding to clip 3, has been filled, indicating that the third clip should be shared.

The element 435 prompts the sharing user to tag the shared clip. The element 460 is a text field into which the sharing user has entered the tag “#LOL.”

The element 465 is a button operable to cause the selected clip to be shared with the target user. For example, after the element 465 is pressed, a clip request may be generated by the user computing device 160 and sent to the media sharing server 110 for further processing and eventual presentation to the user “Friend2.”

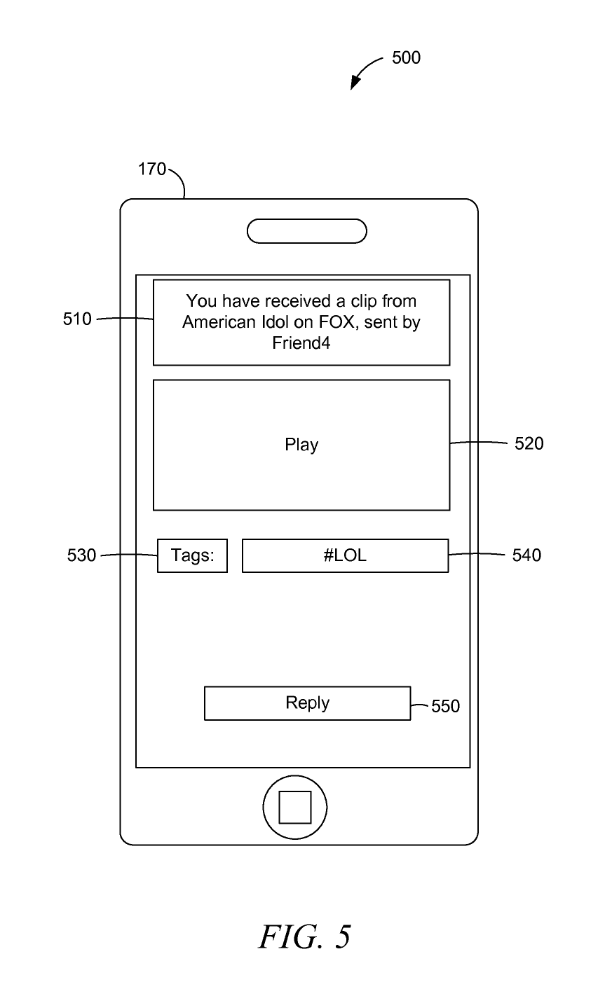

FIG. 5 is a block diagram illustrating a user interface 500 suitable for targeted ad redistribution, according to an example embodiment. The user interface may be displayed on the user computing device 170, for operation by a user receiving a media clip. The element 510 presents information regarding the media currently being shared with the user, including the name or user identifier of the sharing user. The element 520 is operable to cause the playback of the shared clip. The element 530 indicates that the element 540 contains the tags or comments shared by the sharing user. The element 550 is a button operable to send a reply to the sending user. For example, pressing the element 550 may cause an email program running on the user computing device 170 to open and prepare an email addressed to the email address of the sending user. As another example, pressing the element 550 may open a UI allowing the receiving user to send a message via a social media application to the sending user.

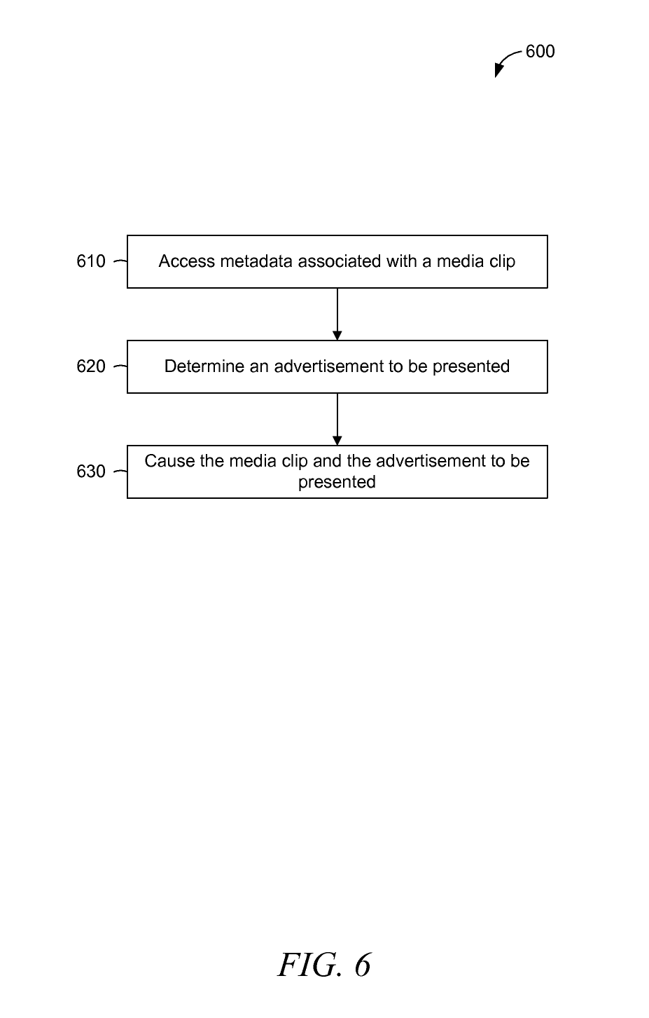

FIG. 6 is a flowchart illustrating operations of the media sharing server 110 in performing a method 600 of targeted ad redistribution, according to an example embodiment. Operations in the method 600 may be performed by the media sharing server 110, using modules described above with respect to FIG. 3. As shown in FIG. 6, the method 600 includes accessing metadata regarding a media clip in operation 610, determining an advertisement to be presented in operation 620, and causing the media clip and the advertisement to be presented in operation 630.

In operation 610, metadata regarding a media clip is accessed. For example, the user 180 of a user computing device 160 may have identified a media clip using a media identifier, a start time, and a start time. The identification for the media clip may have been sent from the user computing device 160 to the media sharing server 110. Based on the received identification, metadata for the media clip may be accessed. For example, a relational database may contain a table that maps the media identifier, start time, and end time to one or more clip identifiers. The relational database may contain another table that maps each clip identifier to one or more pieces of metadata regarding the clip. To illustrate, a user may share a clip that begins one minute into a piece of media and extends for ten seconds. The first mapping table may be accessed to determine that the clip shared by the user spans two previously-identified clips in the database: one beginning at the beginning of the media and extending to one minute, three seconds, and another beginning at one minute, three seconds and extending to one minute, thirty seconds. Based on the two clip identifiers, two rows in the second table may be accessed to retrieve metadata for the clips. Continuing with this illustration, the metadata for the first clip may indicate a brand of a car appearing in the clip, the names of the actors appearing in the clip, and the mood of the clip, such as “action.” The metadata for the second clip may indicate a type of food appearing the clip, the artist performing background music in the clip, and the mood of the clip, such as “calm.”

In operation 620, an advertisement to be presented is determined. The determination may be based on the metadata regarding the media clip accessed in operation 610 and metadata regarding the advertisement. For example, an advertisement for the brand of car appearing in the clip may be selected, based on a match between brand metadata of the advertisement and the clip. As another example, a cheerful advertisement may be selected, based on a match between mood metadata of the advertisement and the clip.

In operation 630, the media clip and the advertisement are caused to be presented. For example, a new piece of media may be created by combining the media clip and the advertisement. The new piece of media may be transmitted from the media sharing server 110 to the user computing device 170 for display or playback on a display device to user 190. The media may be transmitted using HTTP for display in a web browser running in the user computing device 170. The media may be transmitted in a data format appropriate for rendering by a plug-in or by the browser directly (e.g., using the native media capabilities of HTML5). As another example, the selected media clip may be streamed to the user computing device 170, and the selected advertisement sent separately. To illustrate, the selected ad may be a banner ad, and a window containing video of the shared clip may be presented alongside the selected banner ad.

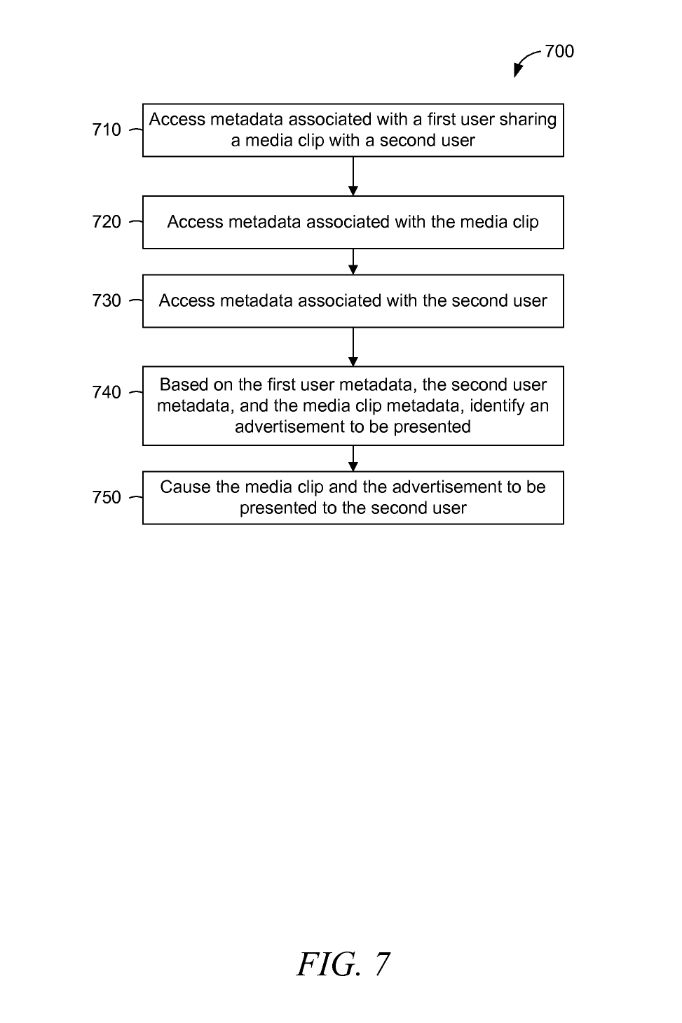

FIG. 7 is a flowchart illustrating operations of the media sharing server 110 in performing a method 700 of targeted ad redistribution, according to an example embodiment. Operations in the method 700 may be performed by the media sharing server 110, using modules described above with respect to FIG. 3. As shown in FIG. 7, the method 700 includes accessing metadata associated with a first user in operation 710, accessing metadata associated with a media clip in operation 720, accessing metadata associated with a second user in operation 730, determining an advertisement to be presented in operation 740, and causing the media clip and the advertisement to be presented to a second user in operation 750.

In operation 710, metadata associated with a first user sharing a media clip with a second user is accessed. For example, user 180 of user computing device 160 may have identified a media clip. The identification for the media clip may have been sent from the user computing device 160 to the media sharing server 110. The communication from the user computing device 160 may include an identification of the first user and the second user. Based on the received identification, metadata for the first user may be accessed. For example, a relational database may contain a table that maps the user identifier to one or more pieces of metadata regarding the user. As another example, a table may map the user identifier to a group identifier while a second table maps the group identifier to metadata regarding the members of the group. The metadata regarding the first user may indicate the user's interests, brand associations, media consumption history, and friends of the first user. For example, the first user may be associated with a brand of car because the user answered a survey and indicated that he or she owned a car of that brand. As another example, the first user may be associated with a brand of cereal because the user previously clicked on a banner ad for that brand of cereal. As yet another example, the metadata may indicate that the first user has an interest in a particular sport, a particular movie star, or a particular author.

In operation 720, metadata associated with the media clip is accessed, as described above with respect to operation 610

In operation 730, metadata associated with the second user is accessed. For example, user 190 of the user computing device 170 may be the second user to whom the clip is shared. A communication from the user computing device 160 sharing the clip may include an identification of the second user. Based on the received identification, metadata for the second user may be accessed. For example, a relational database may contain a table that maps the user identifier to one or more pieces of metadata regarding the user. As another example, a table may map the user identifier to a group identifier while a second table maps the group identifier to metadata regarding the members of the group. The metadata regarding the second user may indicate the user's interests, brand associations, media consumption history, and friends. For example, the second user may be associated with a brand of phone because the user answered a survey and indicated that he or she owned a phone of that brand. As another example, the metadata may indicate that the second user has an interest in a particular sport, a particular movie star, or a particular author. The media consumption history may be a viewing history, a listening history, or a web browsing history. For example, a user may have a digital video recorder (“DVR”) that tracks programs recorded for or viewed by a user. The DVR may communicate information regarding the viewed programs to the media sharing server 110. The media sharing server 110 may store the data regarding the viewed programs in a database. Based on the viewing history, other data regarding the user may be derived. For example, if the user has watched many movies with the same star, a determination that the user is a fan of the star may be made. Likewise, if the user has listened predominantly to music in a certain genre, an association between the user and the genre may be created.

In operation 740, an advertisement to be presented is determined. The determination may be based on the metadata associated with the first user accessed in operation 710, the metadata associated with the second user accessed in operation 730, and the metadata associated with the media clip accessed in operation 720. Additionally, the determination of the advertisement to be presented may be based on the metadata regarding the advertisement. A degree of affinity may be determined for the advertisement and the first user, the advertisement and the second user, and the advertisement and the media clip. The three degrees of affinity may be combined to generate a resulting affinity value for the advertisement. The advertisement with the highest resulting affinity value may be selected to be presented.

For example, the degree of affinity may be a count of matching attributes, a percentage of matching attributes, or another measure. For example, a user may be associated with attributes for “parent,” “pop music,” “BBQ,” and “cheerful.” An advertisement may be associated with attributes for “playful,” “kids,” and “toys.” Another advertisement may be associated with attributes for “party,” “beer,” and “pool.” Based on a determination of a match between “parent” and “kids” as well as “cheerful” and “playful,” an affinity of the user with the first advertisement may be determined. Based on a determination of a match between “cheerful” and “party,” an affinity of the user with the second advertisement may be determined. Based on the strength and/or number of the matches, the affinity of the first advertisement for the user may be higher than the affinity of the second advertisement for the user. Similarly, the affinity of each candidate advertisement for the media clip may be determined. The three affinity values (for the sending user, the receiving user, and the media clip) for each advertisement may be combined. For example, the affinity values may be combined in a weighted sum.

In operation 750, the media clip and the advertisement are caused to be presented to the second user. This may be performed in the manner discussed above with respect to operation 630.

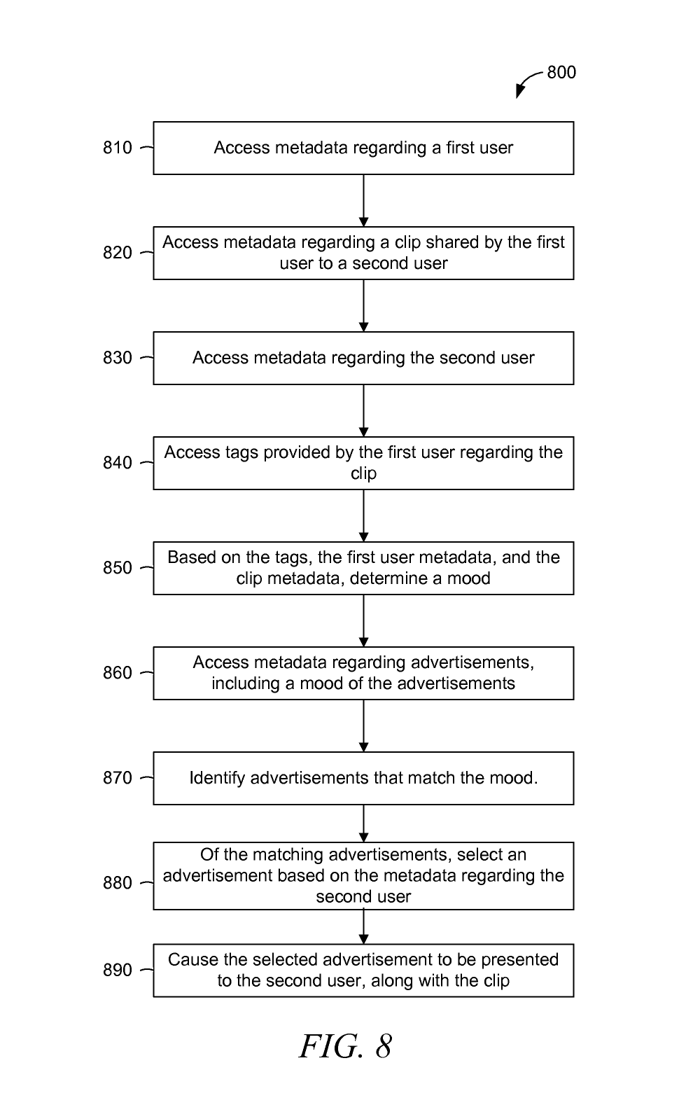

FIG. 8 is a flowchart illustrating operations of the media sharing server 110 in performing a method 800 of targeted ad redistribution, according to an example embodiment. Operations in the method 800 may be performed by the media sharing server 110, using modules described above with respect to FIG. 3. As shown in FIG. 8, the method 800 includes accessing metadata regarding a first user in operation 810, accessing metadata regarding a clip shared by the first user to a second user in operation 820, accessing metadata regarding the second user in operation 830, and accessing tags provided by the first user regarding the clip in operation 840. The method 800 further includes determining a mood based on the tags, the first user metadata, and the second user metadata in operation 850, accessing metadata regarding advertisements in operation 860, and identifying advertisements that match the mood in operation 870. The method 800 further includes selecting a matching advertisement based on the metadata regarding the second user in operation 880 and causing the selected advertisement and the clip to be presented to the second user in operation 890.

In operation 810, metadata regarding a first user is accessed. This operation may be performed in the same manner as operation 710, described above.

In operation 820, metadata regarding a clip shared by the first user to a second user is accessed. This operation may be performed in the same manner as operation 610, described above.

In operation 830, metadata regarding the second user is accessed. This operation may be performed in the same manner as operation 730, described above.

In operation 840, tags provided by the first user regarding the clip are accessed. For example, the first user may enter tags as text or select tags from a pre-defined list. The tags may be sent from the user computing device 160 to the media sharing server 110 as part of the media sharing request, or as separate communications.

In operation 850, a mood is determined based on the tags, the first user metadata, and the clip metadata. The mood may be determined by combining the three types of data or by determining one or more moods based on each type of data and combining the moods. For example, a tag such as “LOL” may indicate a humorous mood, the first user metadata may indicate that the first user has an affinity for comedy and action media, and the second user metadata may indicate that the second user has an affinity for dramatic media. In this example, the mood may be determined to be humorous based on both the tag and the first user metadata indicating a humorous/comedic mood, while the other moods (action and drama) each only apply to one type of data. In another example embodiment, the mood may be maintained as a weighted vector value, such as a vector of 0.5 humor, 0.25 action, and 0.25 drama. An arbitrary number of possible moods and vector lengths may be used.

In operation 860, metadata regarding advertisements is accessed, including a mood of each advertisement. For example, a database of available advertisements may be accessed, wherein the database contains the advertisements and metadata regarding the advertisements. The metadata regarding the advertisements may indicate the type of advertisement (e.g., audio, video, image, text), presentation attributes for the advertisement (e.g., length, compression algorithm, size, resolution), and metadata regarding the content of the advertisement (e.g., actors, product, brand, location, and mood). Thus, a light-hearted advertisement may have a “funny” mood, a science-based ad may have a “serious” mood, and an ad for a funeral parlor may have a “somber” mood.

In operation 870, advertisements matching the mood determined in operation 850 are identified. For example, if the mood identified in operation 850 is “funny” or “humor,” the database of available advertisements accessed in operation 860 may be searched for advertisements having that mood. When multiple moods are used, advertisements matching any of the moods may be identified, and a degree of match determined. To illustrate, if the mood vector is 0.5 humor, 0.25 action, and 0.25 drama, advertisements having humor, action, and drama moods would be full matches, while advertisements having only an action mood would be 25% matches. These partially-matching advertisements may be considered to match if they are above a predetermined or dynamic threshold. For example, any advertisement having at least a 50% match may be considered to be a match. As another example, the ten best-matching advertisements may be considered to be matches.

In operation 880, one of the matching advertisements identified in operation 870 is selected based on the metadata regarding the second user. For example, one of the matching advertisements may be for a product for which the second user has an affinity. Based on the match between the product of the advertisement and the product of interest to the second user, the advertisement may be chosen. As another example, the second user's interests may be used to generate a mood, and an advertisement with a matching mood may be chosen. Multiple criteria may be applied and a weighted score generated for each of the identified advertisements. The identified advertisement with the highest score may be selected.

In operation 890, the selected advertisement and the clip are caused to be presented to the second user. This may be performed in the manner discussed above with respect to operation 630 of FIG. 6.

According to various example embodiments, one or more of the methodologies described herein may facilitate identification of a media source by a device that is not accessing a media stream from the media source. Moreover, one or more of the methodologies described herein may facilitate identification of a full or partial channel line-up that is available to a particular device or a user thereof. Hence, one or more the methodologies described herein may facilitate retrieval and presentation of information regarding the full or partial channel lineup-up, as well as enhanced remote control capabilities by the device without access to media streams from media sources over another device that has access to the media streams from the media sources.

When these effects are considered in aggregate, one or more of the methodologies described herein may obviate a need for certain efforts or resources that otherwise would be involved in sharing media clips and presenting advertisements to users. Efforts expended by a user in sharing a media clip may be reduced by one or more of the methodologies described herein. Efforts expended by an advertiser in identifying users interested in particular ads may be reduced by one or more of the methodologies described herein. Computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 9 is a block diagram illustrating components of a machine 900, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 9 shows a diagrammatic representation of the machine 900 in the example form of a computer system and within which instructions 924 (e.g., software, a program, an application, an applet, an app, or other executable code) for causing the machine 900 to perform any one or more of the methodologies discussed herein may be executed, in whole or in part. In alternative embodiments, the machine 900 operates as a standalone device or may be connected (e.g., networked) to other machines. In a networked deployment, the machine 900 may operate in the capacity of a server machine or a client machine in a server-client network environment, or as a peer machine in a distributed (e.g., peer-to-peer) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924, sequentially or otherwise, that specify actions to be taken by that machine. Further, while only a single machine is illustrated, the term “machine” shall also be taken to include a collection of machines that individually or jointly execute the instructions 924 to perform all or part of any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The machine 900 may further include a graphics display 910 (e.g., a plasma display panel (PDP), a light emitting diode (LED) display, a liquid crystal display (LCD), a projector, or a cathode ray tube (CRT)). The machine 900 may also include an alphanumeric input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a speaker), and a network interface device 920.

The storage unit 916 includes a machine-readable medium 922 on which is stored the instructions 924 embodying any one or more of the methodologies or functions described herein. The instructions 924 may also reside, completely or at least partially, within the main memory 904, within the processor 902 (e.g., within the processor's cache memory), or both, during execution thereof by the machine 900. Accordingly, the main memory 904 and the processor 902 may be considered as machine-readable media. The instructions 924 may be transmitted or received over a network 926 (e.g., network 140 of FIG. 1) via the network interface device 920.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 922 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 900), such that the instructions, when executed by one or more processors of the machine (e.g., processor 902), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing metadata associated with a media clip shared by a sharing user with a target user;
accessing metadata associated with the sharing user;
accessing metadata associated with the target user;
by a processor of a machine, determining an advertisement to be presented based on the metadata associated with the media clip, the metadata associated with the sharing user, and the metadata associated with the target user; and
causing the media clip and the advertisement to be presented to the target user.

2. The method of claim 1, wherein the metadata associated with the sharing user includes a viewing history of the sharing user.

3. The method of claim 1, wherein the metadata associated with the sharing user includes a sharing history of the sharing user.

4. The method of claim 1, further comprising accessing a tag provided by the sharing user regarding the media clip, and wherein the determining of the advertisement to be presented is further based on the tag.

5. The method of claim 1, wherein:
the media clip is a portion of a longer piece of media; and
the metadata associated with the media clip is different from metadata associated with another portion of the longer piece of media.

6. The method of claim 1, further comprising accessing metadata associated with a plurality of advertisements, and wherein:
the advertisement to be presented is one of the plurality of advertisements; and
the determining of the advertisement to be presented is further based on the metadata associated with the plurality of advertisements.

7. The method of claim 6, wherein:
the metadata associated with the plurality of advertisements includes a count indicating a number of times the advertisement to be presented has previously been presented to the target user; and
the determining of the advertisement to be presented is further based on the count.

8. The method of claim 7, wherein:
the metadata associated with the media clip includes a mood of the media clip;
the metadata associated with the plurality of advertisements includes a mood of the advertisement to be presented; and
the determining of the advertisement to be presented is further based on the mood of the advertisement to be presented matching the mood of the media clip.

9. The method of claim 1, wherein the metadata associated with the target user includes a viewing history of the target user.

10. The method of claim 1, wherein the advertisement is embedded into the media clip presented to the target user.

11. The method of claim 1, further comprising analyzing, by the processor of the machine, the media clip to create the metadata associated with the media clip.

12. The method of claim 1, wherein the causing of the media clip and the advertisement to be presented to the target user includes sending the media clip to the target user via a network.

13. The method of claim 1, wherein the causing of the media clip and the advertisement to be presented to the target user includes sending a pointer to the media clip to the target user via a network.

14. A system comprising:
one or more processors configured to:
access metadata associated with a media clip shared by a sharing user with a target user;
access metadata associated with the sharing user;
access metadata associated with the target user;
determine an advertisement to be presented based on the metadata associated with the media clip, the metadata associated with the sharing user, and the metadata associated with the target user; and
cause the media clip and the advertisement to be presented to the target user.

15. The system of claim 14, wherein the metadata associated with the sharing user includes a viewing history of the sharing user.

16. The system of claim 14, wherein the metadata associated with the sharing user includes a sharing history of the sharing user.

17. The system of claim 14, wherein the one or more processors are further configured to access a tag provided by the sharing user associated with the media clip, and wherein the determining of the advertisement to be presented is further based on the tag.

18. The system of claim 14, wherein:
the media clip is a portion of a longer piece of media; and
the metadata associated with the media clip is different from metadata associated with another portion of the longer piece of media.

19. The system of claim 14, wherein the one or more processors are further configured to access metadata associated with a plurality of advertisements, and wherein:
the advertisement to be presented is one of the plurality of advertisements; and
the determining of the advertisement to be presented is further based on the metadata associated with the plurality of advertisements.

20. A non-transitory machine-readable storage medium comprising instructions that, when executed by one or more processors of a machine, cause the machine to perform operations comprising:
accessing metadata associated with a media clip shared by a sharing user with a target user;
accessing metadata associated with the sharing user;
accessing metadata associated with the target user;
determining an advertisement to be presented based on the metadata associated with the media clip, the metadata associated with the sharing user, and the metadata associated with the target user; and
causing the media clip and the advertisement to be presented to the target user.
